(19) United States
(12) Patent Application Publication
(10) Pub. No.: US 2004/0000441 A1
(43) Pub. Date: Jan. 1, 2004

(54) Motor vehicle with a drive assembly and with an operating medium reservoir

(76) Inventor: Jens Arik Almkermann, Calberlah (DE)

Correspondence Address: Peter N. Lalos, Stevens, Davis, Miller & Mosher, LLP, Suite 850, 1615 L Street, NW, Washington, DC, 20036-5622, US

(21) Appl. No.: 10/428,125

(22) Filed: May 2, 2003

(30) Foreign Application Priority Data
May 2, 2002 (DE) 102 19 429.7

(51) Int. Cl. B62M 1/10

(52) U.S. Cl. 180/165

(57) ABSTRACT

The motor vehicle contains a drive assembly (10) having at least one waste heat operating unit (16) and one operating medium reservoir (14).

Provision is made such that the operating medium reservoir (14) is at least temporarily operationally connected to the waste heat operating unit (16) for the purpose of heating the operating medium.

### DESCRIPTION

The invention relates to a motor vehicle with at least one drive assembly having a waste heat function unit and with an operating medium reservoir, as specified in the preamble of claim 1.

Motor vehicles of the type indicated above are of the state of the art. For the sake of proper operation of the drive assembly, such as one in the form of an internal combustion engine system and/or a fuel cell system, the operating medium reservoir or operating medium must be heated in order for it to be possible to use it (for example, a hydrocarbon or hydrogen) for propulsion or operation of the motor vehicle. Up to the present heating of the operating medium in a generic motor vehicle has been carried out in a relatively costly manner.

The object of the invention is to propose a motor vehicle of the type indicated above in which adequate and relatively simple heating of the operating medium is possible.

This object is attained by a motor vehicle having the characteristics specified in claim 1. It is claimed for the invention that the motor vehicle is characterized in that the operating medium reservoir is operationally connected at least temporarily to the waste heat function unit for operating medium heating. The operating medium reservoir may be heated to a desired operating temperature at relatively low cost by use of the waste heat already present in the motor vehicle for heating of the operating medium. As a result, it is possible optionally also to at least to reduce or even completely eliminate such relatively costly use of other heating units to be provided expressly for heating of the operating medium in the motor vehicle.

The waste heat function unit is preferably a waste gas control system. In addition or as an alternative, the waste heat function unit may be a coolant circulation system. Since operating medium reservoir temperatures below 100° may be adequate for operation of such operating medium reservoir, optionally different waste heat function units used in a motor vehicle may be used as a suitable heat source in this connection.

In one possible embodiment the waste heat function unit may be part of an internal combustion engine system and/or part of a fuel cell system. The operating medium reservoir may accordingly be connected to an internal combustion engine and/or to a fuel cell unit for admission of the operating medium. In addition, the operating medium may be a substance such as, in particular a hydrocarbon (biogenic fuel) or hydrogen. This makes it possible to deliver fuel and/or hydrogen, after its heating favoring operation to a specific predetermined operating temperature, the fuel to the internal combustion engine and/or the suitably heated hydrogen to the fuel cell unit.

In one preferred embodiment the operating medium reservoir is in the form of a pressurized tank or cryoreservoir or metal hydride reservoir. Only small amounts of hydrogen are to be stored in the motor vehicle in the case of such types of operating medium reservoirs. The hydrogen serves the purpose of operating medium for operation of the fuel cell unit. Because of their relatively low power density, metal hydride reservoirs are currently used in a motor vehicle exclusively for a relatively small operating medium (hydrogen) tank content. They are charged under pressure with gaseous hydrogen, but must be heated to be able to release hydrogen molecules again from the atomic structure of the metal lattice. Cryoreservoirs also require an external supply of thermal energy for controlled release of the stored hydrogen. Cryoreservoirs contain liquid hydrogen, which preferably is vaporized immediately after its removal from the tank, so that it may subsequently be supplied to an internal combustion engine, for example, by relatively simple means without change in phase.

The operating medium reservoir is connected to the waste heat function unit by serial connection of at least one heat exchanger. Adequate heating of the operating medium can be effected in an efficiency-promoting and possibly flexible manner by means of at least one heat exchanger.

The operating medium reservoir may additionally be operationally connected to advantage to a latent heat reservoir as heat source. The latent heat reservoir may be effectively used for operating medium heating, for example, in the event of insufficient availability of waste heat during cold starting of an internal combustion engine and/or a fuel cell unit of the motor vehicle, so that a cold start phase must be effectively bridged over, a phase in which the operating medium is rapidly and reliably heated by means of the latent heat reservoir, at least up to the point at which the waste heat function unit supplies adequate waste heat for heating of the operating medium. Consequently, the time required for preparation of the operating medium for the internal combustion engine and/or for the fuel cell unit in cold starting is greatly reduced by means of the latent heat which may be transferred immediately on demand.

The latent heat reservoir is preferably integrated into operating medium circulation of the operating medium reservoir. This permits compact configuration of the internal combustion engine system and/or the fuel cell system, as well as efficiency promoting transfer of latent heat to the operating medium reservoir, especially if the waste heat control system (exhaust gas train) and/or the coolant circulation system of the motor vehicle requires a significant heating period in order to be able to guarantee adequate heating of the operating medium.

The fuel cell unit preferably is designed as an auxiliary energy preparation unit. Use of such a fuel cell unit is to be recommended in particular in order to meet the constantly rising demand for electric power in the motor vehicle. Generation of current by means of the fuel cell unit is far more efficiency-promoting than by means of a generator driven by the internal combustion engine. Use of an auxiliary energy preparation unit in the form of a fuel cell unit is effective especially in luxury vehicles, which have a large number of current consuming devices on board.

The fuel cells may be in the form of diaphragm or solid-oxide fuel cells. Such fuel cells are of the state of the art and are operated for generation of electric current with hydrogen. Diaphragm fuel cells are also designated as PEM fuel cells and solid-oxide fuel cells, also designated as SOFC fuel cells.

Preferably a control unit is provided for control of the feeding of heat to a fuel circulation system of the operating medium reservoir as a function of the respective electric fuel cell charge. This makes it possible to guarantee adequate and rapid supply of the fuel cell unit and/or fuel cells with operating medium (hydrogen in particular) from the operating medium reservoir.

In one preferred embodiment the latent heat reservoir is additionally operationally connected, at least temporarily, to the fuel cells for cold start heating of such cells. This can be accomplished, for example, by coupling the fuel cell cooling circuit to the operating medium circuit of the operating medium reservoir, so that latent heat may also be used for heating the fuel cells, optionally in addition to and/or simultaneously with heating of the operating medium.

Other advantageous configurations of the invention are given in the specification.

The invention is described in detail in what follows on the basis of a plurality of exemplary embodiments with reference to an accompanying drawing, in which

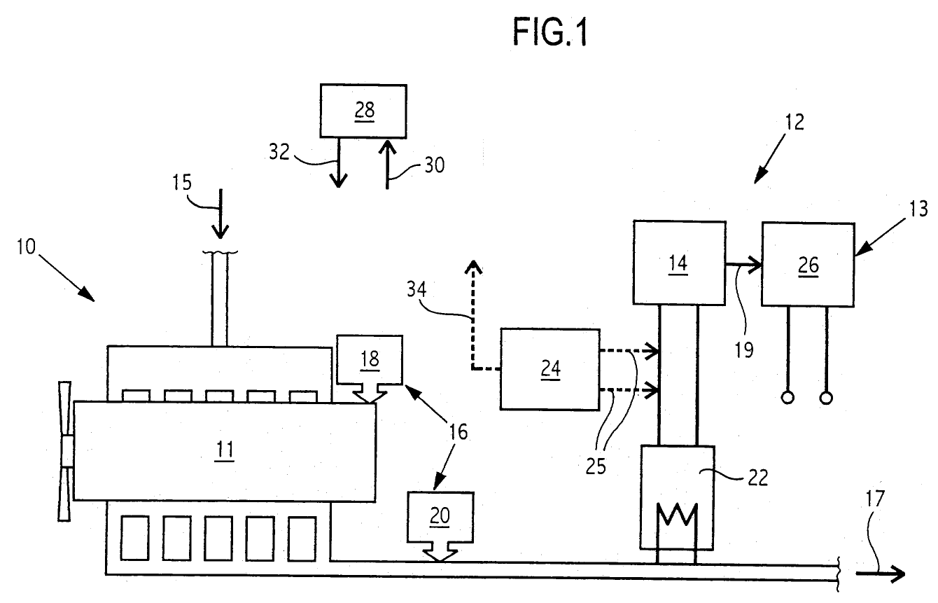

FIG. 1 presents a diagram of a fuel cell system claimed for the invention, one which is operationally connected to a waste heat function unit of an internal combustion engine;

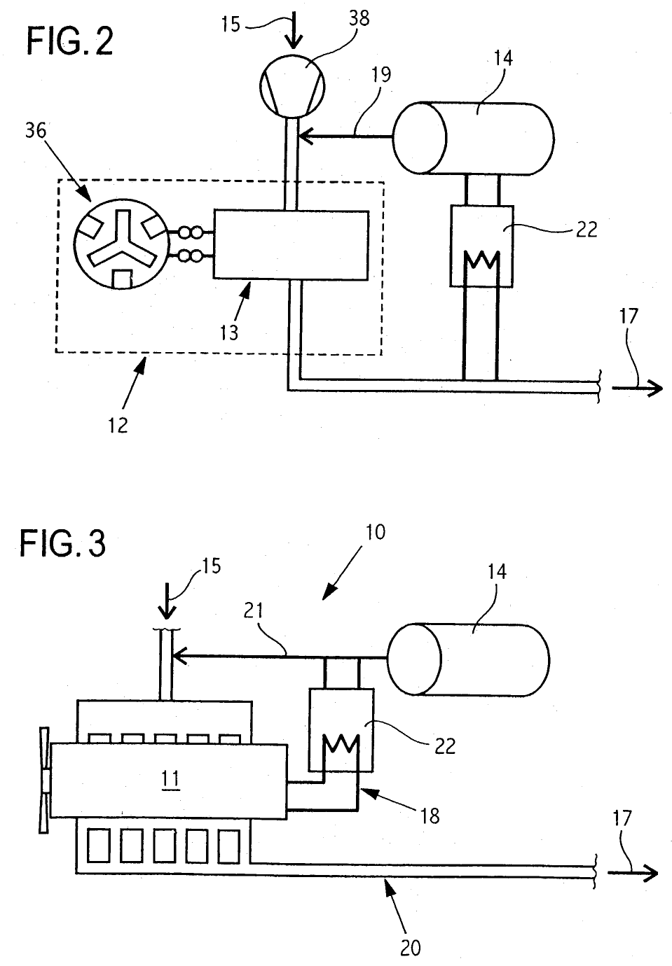

FIG. 2 a diagram of a fuel cell system claimed for the invention in an alternative embodiment; and

FIG. 3 a diagram of an internal combustion engine system claimed for the invention in another alternative embodiment.

FIG. 1 shows an internal combustion engine system 10 of a motor vehicle (not shown) which is connected to a fuel cell system 12. The internal combustion engine system 10 comprises an internal combustion engine 11 serving as the drive assembly of the motor vehicle to which fuel (arrow 15) may be introduced. The fuel cell system 12 has a fuel cell unit 13 which performs the function of an auxiliary energy preparation unit and effects more efficiency-promoting current generation in comparison to a generator powered by an internal combustion engine 11. The fuel cell system 12 has an operating medium reservoir 14, which may be in the form of a pressure accumulator or that of a cryoreservoir or as metal hydride reservoir, for example. As is indicated by arrow 19, the operating medium reservoir 14 is connected to a plurality of fuel cells 26 of the fuel cell unit 13. The fuel cells 26 preferably are in the form of diaphragm or solid oxide fuel cells and are operated by a conventional method with hydrogen as operating medium. To ensure an adequate hydrogen supply of the fuel cells 26 by the operating medium reservoir 14 (H₂ reservoir), waste heat of an internal combustion engine drive train is used for operation of the operating medium reservoir 14.

In the case of a metal hydride reservoir 14, this reservoir is filled with gaseous hydrogen under pressure. The metal hydride reservoir 14 must be heated in order to release H₂ molecules from the atomic metal lattice structure. The heat required for this purpose is to advantage decoupled from the conventional drive train of the motor vehicle. Heating of the operating medium takes place in the metal hydride reservoir 14 by means of an internal combustion engine waste heat operating unit 16, which may be operationally connected at least temporarily to the metal hydride reservoir 14 for this purpose. The waste heat operating unit 16 may in this instance be a coolant circulation system 18 of the motor vehicle drive unit (internal combustion engine 11) and/or an exhaust gas conduit system 20 of the internal combustion engine 11. In the exemplary embodiment shown in FIG. 1, waste heat from the exhaust gas conduit system 20 is used for operating medium heating in the metal hydride reservoir 14 by interconnection of a heat exchanger 22. The exhaust gas may then be conducted to another operating unit (not shown in FIG. 1) of the motor vehicle as indicated by the arrow 17.

The metal hydride reservoir 14 may additionally be operationally connected at least temporarily to a latent heat reservoir 24 as heat source for heating the operating medium. Latent heat is thus used for operating medium heating by the latent heat reservoir 24, as indicated by the arrows 25. The latent heat reservoir 24 is used in particular for rapid provision of the heat required for operation of the fuel cell unit 13 during a cold start phase of the internal combustion engine 11 in which waste heat of the internal combustion engine cannot be used at all or cannot be adequately used for operating medium heating. The latent heat of the latent heat reservoir 24 may be used, at least temporarily, for operation of the metal hydride reservoir 14 (arrows 25) and/or for heating the fuel cells 26 (arrow 34). This makes it possible to cover the electric energy requirement in the motor vehicle even during starting (even cold starting) of the motor vehicle. The possibility of rapidly using the fuel cell unit 13 allows relatively low expenditure of the energy content of an additional permanent storage unit (a battery, for example) of the motor vehicle for bridging a particular starting phase, especially a cold start phase. The immediate availability of the latent heat for preheating the fuel cells reduces the transitional period after which the electrochemical fuel cell process employed permits independent heating of the fuel cells 26 (fuel cell stack).

Also provided in the embodiment illustrated in FIG. 1 is a control unit 28, especially for control of the heat introduced into the operating medium cycle of the operating medium reservoir 14 (a metal hydride reservoir, for example) as a function of the fuel cell load required in each instance. In addition, the control unit 28 may be operationally connected to other operating units of the internal combustion engine system 10 and/or the fuel cell system 12 (arrows 30, 32).

FIGS. 2 and 3 illustrate alternative embodiments of a possible area of application of an operating medium reservoir in a motor vehicle and of possible use of waste heat for heating the operating medium reservoir and/or the operating medium to a desired operating temperature.

FIG. 2 illustrates an operating medium reservoir 14 of a fuel cell system 12 which is in the form of a hydrogen reservoir and, as indicated by arrow 19, is connected to a fuel cell unit 13 into which hydrogen is introduced. The fuel cell unit 13 admits at least one other fuel by way of a compressor 38, as indicated by arrow 15, and is used for generation of electric current used for operation of an electric motor 36. The fuel cell waste gas to be removed as indicated by arrow 17 is used at least temporarily with an interconnected heat exchanger 22 for heating the operating medium reservoir 14 and/or the operating medium (hydrogen) to be fed to the fuel cell unit 13.

FIG. 3 shows an operating medium reservoir 14 of an internal combustion engine system 10 which may be in the form of a hydrogen reservoir and/or of a hydrocarbon reservoir and which is connected to an internal combustion engine 11 for introduction of an operating medium to such engine as indicated by arrow 21. The internal combustion engine 11 is additionally supplied with a fuel as indicated by arrow 15. As is illustrated in FIG. 3, it is not, as in FIG. 1, an exhaust gas conduit system 20—as in FIG. 1, but a coolant circulation system 18 which is used, with an interconnected heat exchanger 22, to heat the operating medium of the operating medium reservoir 14. The internal combustion engine exhaust gas is fed to another operating unit (not shown in FIG. 3) of the internal combustion engine of the motor vehicle, as is indicated by arrow 17.

It is accordingly claimed for the invention that a plurality of concepts are conceivable for heating of the operating medium and optionally combined fuel cell preheating in a motor vehicle. Different types of drive trains, fuel cells, and/or fuels may be used in different combinations for application of operation-optimized waste heat management. Advantageous increase in the overall efficiency of the system can be achieved by means of thermal integration of otherwise unused waste heat in the motor vehicle. The increase in efficiency results both from effective operating medium reservoir control and, when a fuel cell system is used, from a higher supplied hydrogen temperature, which entails a lower energy requirement for execution of subsequent fuel cell conduit preheating. When use is made of a conventional internal combustion engine drive train, a fuel vaporizer, an electric one in particular, may be omitted.

1. A motor vehicle with a drive assembly having at least one waste heat operating unit and with an operating medium reservoir, characterized in that the operating medium reservoir (14) is at least temporarily operationally connected to the waste heat operating unit (16) for the purpose of heating of the operating medium.

2. The motor vehicle as claimed in claim 1, wherein the waste heat operating unit (16) is an exhaust gas conduit system (20).

3. The motor vehicle as claimed in one of the foregoing claims, wherein the waste heat operating unit (16) is a coolant circulation system (18).

4. The motor vehicle as claimed in one of the foregoing claims, wherein the waste heat operating unit (16) is part of an internal combustion engine system (10) and/or part of a fuel cell system (12).

5. The motor vehicle as claimed in one of the foregoing claims, wherein the operating medium reservoir (14) is connected to an internal combustion engine (11) and/or to a fuel cell unit (13) for the purpose of introduction of an operating medium.

6. The motor vehicle as claimed in one of the foregoing claims, wherein the operating medium is a fuel, hydrocarbon in particular, or hydrogen.

7. The motor vehicle as claimed in one of the foregoing claims, wherein the operating medium reservoir (14) is in the form of a pressure reservoir or of a cryoreservoir or of a metal hydride reservoir.

8. The motor vehicle as claimed in one of the foregoing claims, wherein the operating medium reservoir (14) is connected to the waste heat operating unit (16) by interconnection of at least one heat exchanger (22).

9. The motor vehicle as claimed in one of the foregoing claims, wherein the operating medium reservoir (14) is at least temporarily operationally connected in addition to a latent heat reservoir (24) as heat source.

10. The motor vehicle as claimed in one of the foregoing claims, wherein the latent heat reservoir (24) is integrated into an operating medium cycle of the operating medium reservoir (14).

11. The motor vehicle as claimed in one of the foregoing claims, wherein the fuel cell unit (13) is in the form of an auxiliary energy preparation unit.

12. The motor vehicle as claimed in one of the foregoing claims, wherein the fuel cells (26) are in the form of diaphragm or solid oxide fuel cells.

13. The motor vehicle as claimed in one of the foregoing claims, wherein a control unit (28) is provided for control of the heat introduced in an operating cycle of the operating medium reservoir (14) as a function of the electric fuel cell charge required in each instance.

14. The motor vehicle as claimed in one of the foregoing claims, wherein the latent heat reservoir (24) is operationally connected, at least temporarily, in addition to the fuel cells (26) for cold-start heating of such cells.
